(19) United States
(12) Patent Application Publication
(10) Pub. No.: US 2024/0056147 A1
(43) Pub. Date: Feb. 15, 2024

(54) CSI-RS Resource Reuse for Different Antenna Ports

(71) Applicant: Telefonaktiebolaget LM Ericsson (PUBL), Stockholm (SE)

(72) Inventors: Sebastian Faxer, Stockholm (SE); Siva Muruganathan, Stittsville (CA); Shiwei Gao, Nepean (CA); Robert Mark Harrison, Grapevine, TX (US); Mattias Frenne, Uppsala (SE); Claes Tidestav, BÃLSTA (SE)

(21) Appl. No.: 17/766,348

(22) PCT Filed: Oct. 5, 2020
(86) PCT No.: PCT/SE20/50944

§ 371 Date: Apr. 4, 2022

Related U.S. Application Data
(60) Provisional application No. 62/910,715, filed on Oct. 4, 2019.

(51) Int. Cl. H04B 7/06

(52) U.S. Cl. CPC H04B 7/0626; H04B 7/0639

(57) ABSTRACT

A method by a wireless device for computing channel state information (CSI) includes obtaining an overlapping N-port CSI-RS resource definition that overlaps with an M-port CSI-RS resource definition. A number N of ports associated with the overlapping N-port CSI-RS resource definition is less than a number M of ports associated with the M-port CSI-RS resource definition. The wireless device calculates N-port CSI based on the overlapping N-port CSI-RS definition and reports the N-port CSI to a network node.

### TECHNICAL FIELD

The present disclosure relates, in general, to wireless communications and, more particularly, systems and methods for Channel State Information-Reference Signal (CSI-RS) resource reuse for different antenna ports.

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

The Third Generation Partnership Project (3GPP) Fifth generation (5G) New Radio (NR) standard is currently evolving with enhanced MIMO support. A core component in NR is the support of MIMO antenna deployments and MIMO related techniques such as spatial multiplexing. The spatial multiplexing mode is aimed for high data rates in favorable channel conditions. FIG. 1 illustrates a spatial multiplexing operation. More specifically, FIG. 1 illustrates a transmission structure of precoded spatial multiplexing mode in NR.

As illustrated in FIG. 1, the information carrying symbol vector s is multiplied by an N_{T}×r precoder matrix W, which distributes the transmit energy in a subspace of the N_{T} (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer and r is referred to as the transmission rank. In this way, spatial multiplexing is achieved because multiple symbols can be transmitted simultaneously over the same time/frequency resource element (TFRE). The number of symbols r is typically adapted to suit the current channel properties.

NR uses orthogonal frequency division multiplexing (OFDM) in the downlink (and discreet Fourier transform (DFT) precoded OFDM in the uplink) and hence the received N_{R}×1 vector yₙ for a certain TFRE on subcarrier n (or alternatively data TFRE number n) is thus modeled by

yₙ=HₙWsₙeₙ

where eₙ is a noise/interference vector obtained as realizations of a random process. The precoder W can be a wideband precoder, which is constant over frequency, or frequency selective.

The precoder matrix W is often chosen to match the characteristics of the N_{R}×N_{T} MIMO channel matrix Hₙ, resulting in channel dependent precoding. This is also commonly referred to as closed-loop precoding and essentially strives for focusing the transmit energy into a subspace which is strong in the sense of conveying much of the transmitted energy to the UE.

In closed-loop precoding for the NR downlink, the UE transmits, based on channel measurements in the forward link (downlink), recommendations to the gNB of a suitable precoder to use. The gNB configures the UE to provide feedback according to CSI-ReportConfig and may transmit CSI-RS and configure the UE to use measurements of CSI-RS to feed back recommended precoding matrices that the UE selects from a codebook. A single precoder that is supposed to cover a large bandwidth (wideband precoding) may be fed back. It may also be beneficial to match the frequency variations of the channel and instead feed back a frequency-selective precoding report, e.g. several precoders, one per subband. This is an example of the more general case of channel state information (CSI) feedback, which also encompasses feeding back other information than recommended precoders to assist the gNodeB in subsequent transmissions to the UE. Such other information may include channel quality indicators (CQIs) as well as transmission rank indicator (RI). In NR, CSI feedback can be either wideband, where one CSI is reported for the entire channel bandwidth, or frequency-selective, where one CSI is reported for each subband, which is defined as a number of contiguous resource blocks ranging between 4-32 PRBs depending on the band width part (BWP) size.

Given the CSI feedback from the UE, the gNB determines the transmission parameters it wishes to use to transmit to the UE, including the precoding matrix, transmission rank, and modulation and coding scheme (MCS). The transmission parameters may differ from the recommendations the UE makes. The transmission rank, and thus the number of spatially multiplexed layers, is reflected in the number of columns of the precoder W. For efficient performance, it is important that a transmission rank that matches the channel properties is selected.

Particular embodiments presented later herein may be used with two-dimensional antenna arrays. Such antenna arrays may be (partly) described by the number of antenna elements corresponding to the horizontal dimension Nₕ, the number of antenna elements corresponding to the vertical dimension Nᵥ and the number of dimensions corresponding to different polarizations Nₚ. The total number of antennas is thus N=NₕNᵥNₚ. As used herein, the concept of an antenna is non-limiting in the sense that it can refer to any virtualization (e.g., linear mapping) of the physical antenna elements. For example, pairs of physical sub-elements could be fed the same signal, and hence share the same virtualized antenna port.

FIG. 2 illustrates an example of a 4×4 array with cross-polarized antenna elements. More specifically, FIG. 2 is an illustration of a two-dimensional antenna array of cross-polarized antenna elements (Nₚ=2), with Nₕ=4 horizontal antenna elements and Nᵥ=4 vertical antenna elements.

Precoding may be interpreted as multiplying the signal with different beamforming weights for each antenna prior to transmission. A typical approach is to tailor the precoder to the antenna form factor, i.e. taking into account Nₕ, Nᵥ, and Nₚ when designing the precoder codebook.

For CSI measurement and feedback, CSI reference signals (CSI-RS) are defined. A CSI-RS is transmitted on each transmit antenna (or antenna port) and is used by a UE to measure the downlink channel between each of the transmit antenna ports and each of its receive antenna ports. The antenna ports are also referred to as CSI-RS ports. The supported number of antenna ports in NR are {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain resource elements (REs) in a slot and certain slots. FIG. 3 illustrates an example CSI-RS RE allocation for 12 antenna ports, where 1RE per resource block (RB) per port is shown.

An antenna port is equivalent to a reference signal resource that the UE uses to measure the channel. Thus, a gNB with two antennas could define two CSI-RS ports, where each port is a set of resource elements in the time frequency grid within a subframe or slot. The base station transmits each of these two reference signals from each of the two antennas so that the UE can measure the two radio channels and report channel state information back to the base station based on these measurements.

The sequence used for CSI-RS is r(m) and is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence c(i) is defined in clause 5.2.1 of 3GPP TS 38.211. The pseudo-random sequence generator is initialised with

cᵢₙᵢₜ=(2¹⁰(N_{symb}^{slot}n_{s,f}^{μ}+l+1)(2n_{ID}+1)+n_{ID})mod 2³¹

at the start of each OFDM symbol where n_{s,f}^{μ} is the slot number within a radio frame, l is the OFDM symbol number within a slot, and n_{ID}) equals the higher-layer parameter scramblingID or sequenceGenerationConfig.

There are 18 different CSI-RS resource configurations in NR, where each have a specific number of ports X. See Table 1 below. The index kᵢ indicate which first subcarrier in the PRB that is used for mapping the CSI-RS sequence to resource elements, where the second subcarrier is kᵢ+1. The set (kᵢ, kᵢ+1) of subcarriers are denoted as a code division multiplexing (CDM) group for that particular OFDM symbol, where index i may be interpreted as the CDM group index. The index lᵢ indicates the OFDM symbol within the slot. Thus, for example, the configuration given by row 4 is a X=4 port CSI-RS resource where two CDM groups are used, first starting at subcarrier k₀ and the second starting at subcarrier k₀+2 (=k₁) , both in the same OFDM symbol l₀. (Note that kᵢ and lᵢ are parameters signalled from gNB to UE by Radio Resource Control (RRC) signalling when configuring the CSI-RS resource).

Moreover, CSI-RS ports are numbered within a CDM group first and then across CDM groups. So, in this example, CSI-RS port 0 and 1 maps to the CDM group indicated by k₀ and port 2 and 3 maps to the CDM group indicated by k₀+2.

This is captured in the 3GPP specifications that the CSI-RS port indices p are numbered as

p=3000+s+jL;

j=0, 1, . . . , N/L−1

s=0, 1, . . . , L−1

where s is the sequence index provided by Tables 7.4.1.5.3-2 to 7.4.1.5.3-5, below L∈{1,2,4,8} is the CDM group size, and N is the number of CSI-RS ports. The CDM group index j is given in Table 1 and corresponds to the time/frequency locations (k̅, l̅) for a given row of the table. The CDM groups are numbered in order of increasing frequency domain allocation first and then increasing time domain allocation.

For some rows, more than two CDM groups are used and they can be individually mapped to subcarriers, an example is row 10 where three CDM group indices k₀, k₁ and k₂ are used in one and the same symbol given by the RRC configured parameter l₀.

A CDM group can refer to a set of 2, 4 or 8 antenna ports, where the set of 2 antenna ports occurs when only CDM in frequency-domain (FD-CDM) over two adjacent subcarriers is considered. Table 1 shows CSI-RS locations within a slot.

TABLE 1

| Row | Ports X | Density ρ | cdm-Type | (k̅, l̅) | CDM group index j | k′ | l′ |
|---|---|---|---|---|---|---|---|
| 1 | 1 | 3 | No CDM | (k₀, l₀), (k₀ + | 0, 0, 0 | 0 | 0 |
| | | | | 4, l₀), (k₀ + 8, l₀) | | | |
| 2 | 1 | 1, 0.5 | No CDM | (k₀, l₀), | 0 | 0 | 0 |
| 3 | 2 | 1, 0.5 | FD-CDM2 | (k₀, l₀), | 0 | 0, 1 | 0 |
| 4 | 4 | 1 | FD-CDM2 | (k₀, l₀), (k₀ + | 0, 1 | 0, 1 | 0 |
| | | | | 2, 1₀) | | | |
| 5 | 4 | 1 | FD-CDM2 | (k₀, l₀), | 0,1 | 0, 1 | 0 |
| | | | | (k₀, l₀ + 1) | | | |
| 6 | 8 | 1 | FD-CDM2 | (k₀, l₀), (k₁, l₀), | 0, 1, 2, 3 | 0, 1 | 0 |
| | | | | (k₂, l₀), (k₃, l₀) | | | |
| 7 | 8 | 1 | FD-CDM2 | (k₀, l₀), | 0, 1, 2, 3 | 0, 1 | 0 |
| | | | | (k₁, l₀), | | | |
| | | | | (k₀, l₀ + 1), | | | |
| | | | | (k₁, l₀ + 1) | | | |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD-CDM2 | (k₀, l₀), (k₁, l₀), | 0, 1, 2, 3, 4, 5 | 0, 1 | 0 |
| | | | | (k₂, l₀), | | | |
| | | | | (k₃, l₀), (k₄, l₀), | | | |
| | | | | (k₅, l₀) | | | |
| 10 | 12 | 1 | CDM4 | (k₀, l₀), (k₁, l₀), | 0, 1, 2 | 0, 1 | 0, 1 |
| | | | (FD2, TD2) | (k₂, l₀) | | | |
| 11 | 16 | 1, 0.5 | FD-CDM2 | (k₀, l₀), (k₁, l₀), | 0, 1, 2, 3, 4, 5, 6, 7 | 0, 1 | 0 |
| | | | | (k₂, l₀), | | | |
| | | | | (k₃, l₀), | | | |
| | | | | (k₀, l₀ + 1), | | | |
| | | | | (k₁, l₀ + 1), | | | |
| | | | | (k₂, l₀ + 1), | | | |
| | | | | (k₃, l₀ + 1) | | | |
| 12 | 16 | 1, 0.5 | CDM4 | (k₀, l₀), (k₁, l₀), | 0, 1, 2, 3 | 0, 1 | 0, 1 |
| | | | (FD2, TD2) | (k₂, l₀), (k₃, l₀) | | | |
| 13 | 24 | 1, 0.5 | FD-CDM2 | (k₀, l₀), (k₁, l₀), | 0, 1, 2, 3, 4, 5, | 0, 1 | 0 |
| | | | | (k₂, l₀), | 6, 7, 8, 9, 10, 11 | | |
| | | | | (k₀, l₀ + 1), | | | |
| | | | | (k₁, l₀ + 1), | | | |
| | | | | (k₂, l₀ + | | | |
| | | | | 1), (k₀, l₁), | | | |
| | | | | (k₁, l₁), (k₂, l₁), | | | |
| | | | | (k₀, l₁ + 1), | | | |
| | | | | (k₁, l₁ + 1), | | | |
| | | | | (k₂, l₁ + 1) | | | |
| 14 | 24 | 1, 0.5 | CDM4 | (k₀, l₀), (k₁, l₀), | 0, 1, 2, 3, 4, 5 | 0, 1 | 0, 1 |
| | | | (FD2, TD2) | (k₂, l₀), (k₀, l₁), | | | |
| | | | | (k₁, l₁), (k₂, l₁) | | | |
| 15 | 24 | 1, 0.5 | CDM8 | (k₀, l₀), (k₁, l₀), | 0, 1, 2 | 0, 1 | 0, 1, 2, 3 |
| | | | (FD2, TD4) | (k₂, l₀) | | | |
| 16 | 32 | 1, 0.5 | FD-CDM2 | (k₀, l₀), (k₁, l₀), | 0, 1, 2, 3, | 0, 1 | 0 |
| | | | | (k₂, l₀), | 4, 5, 6, 7, | | |
| | | | | (k₃, l₀), (k₀, l₀ + | 8, 9, 10, 11, | | |
| | | | | 1), (k₁, l₀ + 1), | 12, 13, 14, 15 | | |
| | | | | (k₂, l₀ + 1), | | | |
| | | | | (k₃, l₀ + 1), | | | |
| | | | | (k₀, l₁), | | | |
| | | | | (k₁, l₁), (k₂, l₁), | | | |
| | | | | (k₃, l₁), | | | |
| | | | | (k₀, l₁ + 1), | | | |
| | | | | (k₁, l₁ + 1), | | | |
| | | | | (k₂, l₁ + 1), | | | |
| | | | | (k₃, l₁ + 1) | | | |
| 17 | 32 | 1, 0.5 | CDM4 | (k₀, l₀), (k₁, l₀), | 0, 1, 2, 3, 4, 5, 6, 7 | 0, 1 | 0, 1 |
| | | | (FD2, TD2) | (k₂, l₀), (k₃, l₀), | | | |
| | | | | (k₀, l₁), | | | |
| | | | | (k₁, l₁), (k₂, l₁), | | | |
| | | | | (k₃, l₁) | | | |
| 18 | 32 | 1, 0.5 | CDM8 | (k₀, l₀), (k₁, l₀), | 0, 1, 2, 3 | 0, 1 | 0, 1, 2, 3 |
| | | | (FD2, TD4) | (k₂, l₀), (k₃, l₀) | | | |

In more strict mathematical terminology, the mapping of the sequence r(m) onto resource-elements a _{k,l}^{(p,μ)} for CSI-RS antenna port p can be described by:

$${a}_{k , l}^{( p , μ )} = {β}_{CSIRS} {w}_{f} ( {k}^{′} ) \cdot {w}_{t} ( {l}^{′} ) \cdot {r}_{l , {n}_{s , f}} ( {m}^{′} ) \\ {m}^{′} = ⌊ n α ⌋ + {k}^{′} + ⌊ \frac{\overline{k} ρ}{{N}_{sc}^{RB}} ⌋ \\ k = {nN}_{sc}^{RB} + \overline{k} + {k}^{′} \\ l = \overline{l} + {l}^{′} \\ α = \{ \begin{matrix}ρ & for X = 1 \\ 2 ρ & for X > 1\end{matrix} \\ n = 0 , 1 , …$$

For the different CDM types, the following CDM weights are used, where w(k′,l′)=w_{f}(k′)·wₜ(l′) corresponds to the resulting CDM weights formed by the multiplication of the frequency and time-domain CDM weight. TABLE 2 includes the sequences w_{f}(k′) and wₜ(l′) for cdm-Type equal to ‘no CDM’.

TABLE 2

| Index | w_{f}(0) | wₜ(0) |
|---|---|---|
| 0 | 1 | 1 |

TABLE 3 includes sequences w_{f}(k′) and wₜ(l′) for cdm-Type equal to ‘FD-CDM2’.

TABLE 3

| Index | [w_{f}(0) w_{f}(1)] | wₜ(0) |
|---|---|---|
| 0 | [+1 +1] | 1 |
| 1 | [+1 −1] | 1 |

TABLE 4 includes the sequences w_{f}(k′) and wₜ(l′) for cdm-Type equal to ‘CDM4’.

TABLE 4

| Index | [w_{f}(0) wₜ(1)] | [wₜ(0) wₜ(1)] |
|---|---|---|
| 0 | [+1 +1] | [+1 +1] |
| 1 | [+1 −1] | [+1 +1] |
| 2 | [+1 +1] | [+1 −1] |
| 3 | [+1 −1] | [+1 −1] |

TABLE 5 includes sequences w_{f}(k′) and wₜ(l′) for cdm-Type equal to ‘CDM8’.

TABLE 5

| Index | [w_{f}(0) w_{f}(1)] | [wₜ(0) wₜ(1) wₜ(2) wₜ(3)] |
|---|---|---|
| 0 | [+1 +1] | [+1 +1 +1 +1] |
| 1 | [+1 −1] | [+1 +1 +1 +1] |
| 2 | [+1 +1] | [+1 −1 +1 −1] |
| 3 | [+1 −1] | [+1 −1 +1 −1] |
| 4 | [+1 +1] | [+1 +1 −1 −1] |
| 5 | [+1 −1] | [+1 +1 −1 −1] |
| 6 | [+1 +1] | [+1 −1 −1 +1] |
| 7 | [+1 −1] | [+1 −1 −1 +1] |

A common type of precoding is to use a DFT-precoder, where the precoder vector used to precode a single-layer transmission using a single-polarized uniform linear array (ULA) with N antennas is defined as

$${w}_{1 D} ( k ) = \frac{1}{\sqrt{N}} [ \begin{matrix}{e}^{j 2 π \cdot 0 \cdot \frac{k}{QN}} \\ {e}^{j 2 π \cdot 1 \cdot \frac{k}{QN}} \\ ⋮ \\ {e}^{j 2 π \cdot ( N - 1 ) \cdot \frac{k}{QN}}\end{matrix} ] ,$$

where k=0,1, . . . QN−1 is the precoder index and Q is an integer oversampling factor. A corresponding precoder vector for a two-dimensional uniform planar array (UPA) can be created by taking the Kronecker product of two precoder vectors as w_{2D}(k, l)=w_{1D}(k)⊗w_{1D}(1). Extending the precoder for a dual-polarized UPA may then be done as

$$\begin{matrix}{w}_{2 D , DP} ( k , l , ϕ ) = [ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] \\ = [ \begin{matrix}{w}_{2 D} ( k , l ) & 0 \\ 0 & {w}_{2 D} ( k , l )\end{matrix} ] [ \begin{matrix}1 \\ {e}^{j ϕ}\end{matrix} ]\end{matrix}$$

where e^{jϕ} is a co-phasing factor that may for instance be selected from QPSK alphabet

$$ϕ ∈ \{ 0 , \frac{π}{2} , π , \frac{3 π}{2} \} .$$

A precoder matrix W_{2D,Dp} for multi-layer transmission may be created by appending columns of DFT precoder vectors as

W_{2D,DP}=[w_{2D,DP}(k₁, l₁, ϕ₁) w_{2D,DP}(k₂, l₂, ϕ₂) . . . w_{2D,DP}(k_{R}, l_{R}, ϕᵣ)],

where R is the number of transmission layers, i.e. the transmission rank. In a common special case for a rank-2 DFT precoder, k₁=k₂=k and l₁=l₂=l, meaning that

$$\begin{matrix}{W}_{2 D , DP} = [ \begin{matrix}{w}_{2 D , DP} ( k , l , {ϕ}_{1} ) & {w}_{2 D , DP} ( k , l , {ϕ}_{2} )\end{matrix} ] \\ = [ \begin{matrix}{w}_{2 D} ( k , l ) & 0 \\ 0 & {w}_{2 D} ( k , l )\end{matrix} ] [ \begin{matrix}1 & 1 \\ {e}^{j {ϕ}_{1}} & {e}^{j {ϕ}_{2}}\end{matrix} ]\end{matrix} .$$

Such DFT-based precoders are used, for example, in NR Type I CSI feedback. The NR codebook thus assumes an antenna port indexing which maps ports first along the second dimension (identified by the index l, which may be the vertical dimension), then the first dimension (identified by the index k, which may be the horizontal dimension), and then the polarization dimension.

In NR, a UE can be configured with multiple CSI report settings and multiple CSI-RS resource settings. Each resource setting can contain multiple resource sets, and each resource set can contain up to 8 CSI-RS resources. For each CSI report setting, a UE feeds back a CSI report, either periodically or aperiodically (triggered by the network).

Each CSI report setting contains at least the following information:
A CSI-RS resource set for channel measurement
An IMR resource set for interference measurement
Optionally, a CSI-RS resource set for interference measurement
Time-domain behavior, i.e. periodic, semi-persistent, or aperiodic reporting
Frequency granularity, i.e. wideband or subband
CSI parameters to be reported such as RI, PMI, CQI, and CSI-RS resource indicator (CRI) in case of multiple CSI-RS resources in a resource set
Codebook types, i.e. type I or II, and eventual codebook subset restriction
Measurement restriction enabled or disabled
Subband size. One out of two possible subband sizes is indicated, the value range for a subband size depends on the configured bandwidth of the downlink bandwidth part (BWP). One CQI/PMI (if configured for subband reporting) is fed back per subband.

When the CSI-RS resource set in a CSI report setting contains multiple CSI-RS resources, one of the CSI-RS resources is selected by a UE and a CSI-RS resource indicator (CRI) is also reported by the UE to indicate to the gNB about the selected CSI-RS resource in the resource set, together with RI, PMI and CQI associated with the selected CSI-RS resource. The network may then transmit the different CSI-RS resources using different MIMO precoders or by using different beam directions

For aperiodic CSI reporting in NR, more than one CSI report settings, each with a different CSI-RS resource set for channel measurement and/or different resource set for interference measurement can be configured and triggered at the same time, i.e. with a single trigger command in the downlink control channel from the gNB to the UE. In this case, multiple CSI reports are measured, computed, aggregated and sent from the UE to the gNB in a single PUSCH message.

As a general classification, NR categorizes a CSI Report Setting into wideband and subband frequency-granularity as follows:
wideband PMI/CQI reporting, beam reporting, hybrid CSI report, semi-open loop reporting and non-PMI feedback (with wideband CQI) is classified as wideband frequency-granularity CSI, whereas
the other configurations of a CSI Report Setting is classified as having a subband frequency-granularity.

Only CSI Report Settings with wideband frequency-granularity is allowed to be periodically reported on short Physical Uplink Control Channel (PUCCH).

There currently exist certain challenges. For example, a practical cellular system must be able to serve and handle UEs with different capabilities, such as different capabilities in the number of supported CSI-RS ports within a resource. As a particular example, regular UEs may support 32 CSI-RS ports while lower complexity UEs may only support 8 CSI-RS ports. Thus, to serve the two UE complexity categories simultaneously, at least two CSI-RS resources (one 32 port resource and one 8 port resource) will be used, which results in large CSI-RS overhead. Furthermore, because an 8 port CSI-RS resource transmitted from a 32 port antenna array can only probe in a subset of channel directions, the gNB may need to use multiple 8 port CSI-RS resources to serve the lower complexity UEs, which results in even larger overhead. One such lower complexity UE category is described in NR Rel-17 and referred to as “NR Light.”

### SUMMARY

Certain aspects of the present disclosure and their embodiments may provide solutions to these or other challenges. Particular embodiments facilitate reuse of a single Channel State Information-Reference Signal (CSI-RS) resource with M antenna ports for a user equipment (UE) or other wireless device that is only able to calculate, or compute, Channel State Information (CSI) for N<M antenna ports, according to certain various methods that may include indicated port sub-selection, indicated port virtualization, and/or indication of CSI-RS sequence generation.

According to certain embodiments, a method by a wireless device for computing CSI includes obtaining an overlapping N-port CSI-RS resource definition that overlaps with an M-port CSI-RS resource definition. A number N of ports associated with the overlapping N-port CSI-RS resource definition is less than a number M of ports associated with the M-port CSI-RS resource definition. The method further includes calculating N-port CSI based on the overlapping N-port CSI-RS definition and reporting the N-port CSI to a network node.

According to certain embodiments, a wireless device is provided for computing CSI. The wireless device includes processing circuitry configured to obtain an overlapping N-port CSI-RS resource definition that includes an M-port CSI-RS resource definition. A number N of ports associated with the overlapping N-port CSI-RS resource definition is less than a number M of ports associated with the M-port CSI-RS resource definition. The processing circuitry is further configured to calculate N-port CSI based on the overlapping N-port CSI-RS definition and report the N-port CSI to a network node.

According to certain embodiments, a method by a network node is provided for receiving CSI. The method includes transmitting an overlapping N-port CSI-RS resource definition to a wireless device. The N-port CSI-RS resource definition overlaps with an M-port CSI-RS resource definition, and a number N of ports associated with the overlapping N-port CSI-RS resource definition is less than a number M of ports associated with the M-port CSI-RS resource definition. The network node receives CSI from the wireless device according to the overlapping N-port CSI-RS resource definition.

According to certain embodiments, a network node is provided for receiving CSI. The network node includes processing circuitry configured to transmit an overlapping N-port CSI-RS resource definition to a wireless device. The N-port CSI-RS resource definition overlaps with an M-port CSI-RS resource definition, and a number N of ports associated with the overlapping N-port CSI-RS resource definition is less than a number M of ports associated with the M-port CSI-RS resource definition. The processing circuitry is configured to receive CSI from the wireless device according to the overlapping N-port CSI-RS resource definition.

Certain embodiments may provide one or more of the following technical advantages. For example, particular embodiments use a single CSI-RS resource for both regular and low-complexity UEs, resulting in lower CSI-RS overhead and thus improved physical downlink shared channel (PDSCH) throughput.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a spatial multiplexing operation;

FIG. 2 illustrates an example of a 4×4 array with cross-polarized antenna elements;

FIG. 3 illustrates an example Channel State Information-Reference Signal (CSI-RS) Reference Element (RE) allocation;

FIG. 4 illustrates the limitations of legacy CSI-RS resources, according to certain embodiments;

FIG. 5 illustrates an example port subsampling, according to certain embodiments;

FIG. 6 illustrates an example of a ‘parent’ CSI-RS that has a larger CSI-RS, according to certain embodiments;

FIG. 7 illustrates an example wireless network, according to certain embodiments;

FIG. 8 illustrates an example network node, according to certain embodiments;

FIG. 9 illustrates an example wireless device, according to certain embodiments;

FIG. 10 illustrate an example user equipment, according to certain embodiments;

FIG. 11 illustrates a virtualization environment in which functions implemented by some embodiments may be virtualized, according to certain embodiments;

FIG. 12 illustrates a telecommunication network connected via an intermediate network to a host computer, according to certain embodiments;

FIG. 13 illustrates a generalized block diagram of a host computer communicating via a base station with a user equipment over a partially wireless connection, according to certain embodiments;

FIG. 14 illustrates a method implemented in a communication system, according to one embodiment;

FIG. 15 illustrates another method implemented in a communication system, according to one embodiment;

FIG. 16 illustrates another method implemented in a communication system, according to one embodiment;

FIG. 17 illustrates another method implemented in a communication system, according to one embodiment;

FIG. 18 illustrates an example method by a wireless device, according to certain embodiments;

FIG. 19 illustrates an example virtualization apparatus, according to certain embodiments;

FIG. 20 illustrates another example method by a wireless device, according to certain embodiments;

FIG. 21 illustrates another example virtualization apparatus, according to certain embodiments;

FIG. 22 illustrates an example method by a network node, according to certain embodiments; and

FIG. 23 illustrates another example virtualization apparatus, according to certain embodiments.

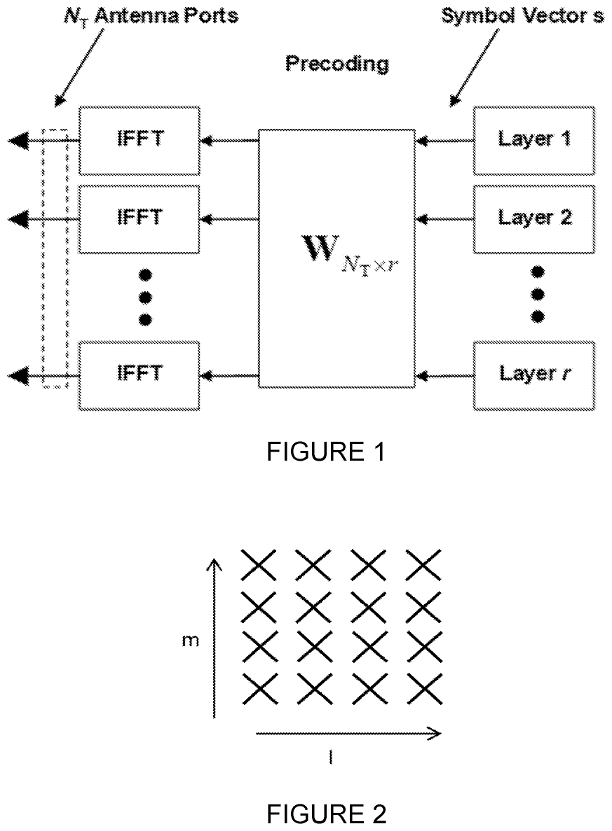

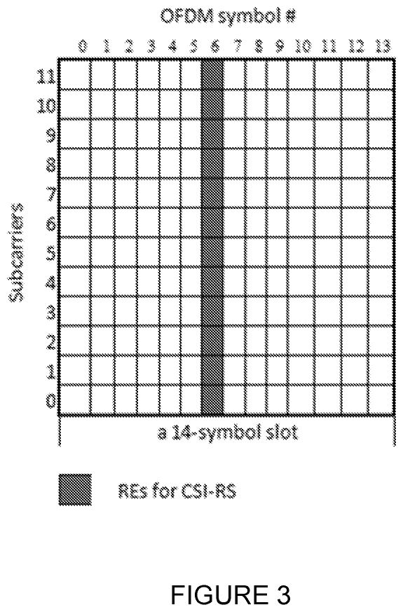

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

It is beneficial for the gNodeB (gNB) to be able to reuse a larger, M ports, Channel State Information-Reference Signal (CSI-RS) resource for measurement for a user equipment (UE) that is only capable of calculating Channel State Information (CSI) for and/or measuring on a smaller number N antenna ports to reduce the amount of CSI-RS resources/ports transmitted and thereby reduce the overhead on the physical layer, which leaves more resources for physical downlink shared channel (PDSCH) transmission. Particular examples described herein may use the special case where M=32 ports and N=8 ports, but the embodiments described herein apply to other values of M and N.

Particular embodiments include a new N-port CSI-RS resource definition, which is configured by the gNB to the UE or other wireless device. The N-port CSI resource definition has the characteristic that it can overlap with an existing, legacy M-port CSI-RS resource definition (which may have been configured by the gNB to another UE or wireless device) and that the UE or other wireless device can still derive meaningful CSI. This is not possible with existing CSI-RS resource definitions.

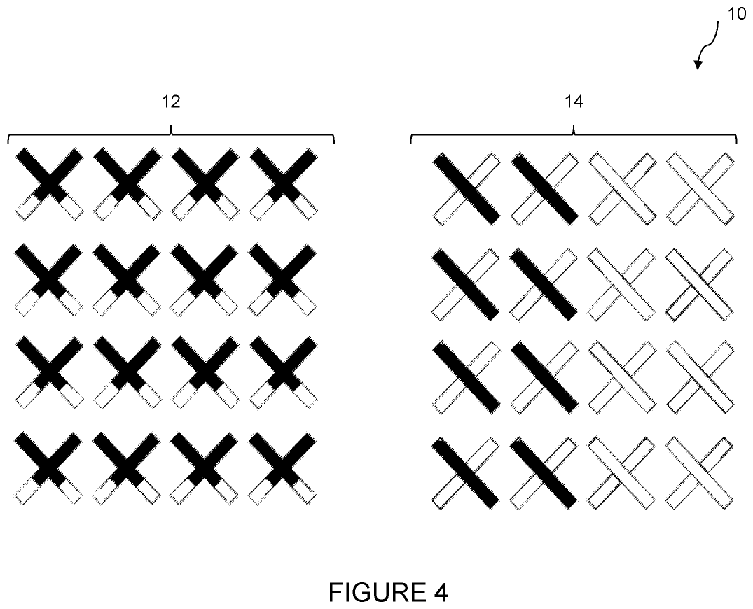

While it is possible to configure, for example, an 8-port resource (e.g., row 8 of Table 1) overlapping with a 32 port resource (row 17 of Table 1), the UE will not report meaningful CSI. FIG. 4 illustrates the limitations of legacy CSI-RS resources, according to certain embodiments. Specifically, FIG. 4 is an illustration of a configuration 10 of overlapping legacy CSI-RS resources. The antenna mapping of 32 port CSI-RS resource 12 is illustrated to the left and the antenna mapping of an 8-port CSI-RS resource 14 is illustrated the right.

Assume that the gNB uses a (N₁, N₂)=(4,4) antenna port configuration for the 32-port CSI-RS. Each of the 8 CDM-groups (k₀, l₀), (k₁, l₀), (k₂, l₀), (k₃, l₀), (k₀, l₁), (k₁, l₁), (k₂, l₁), (k₃, l₁) of CSI-RS configuration 17 corresponds to one column of a polarization of the antenna array. So while the gNB can configure the overlapping CSI-RS configuration 8, which is identified by CDM groups (k₀, l₀), (k₁, l₀) (note that the values k₀, k₁, l₀ configured to the 8-port CSI-RS resource can be different than the k₀, k₁, l₀ values configured to the 32-port CSI-Rs resource, so it is for instance possible to configure k₁^{(8-port)}=k₃(₃^{32-port}), it is constrained in such a way that only two antenna columns of the same polarization can be measured by the UE. Not only cannot the full dual-polarized antenna array be sounded, which limits the channel subspace being observable by the UE, the corresponding 8-port antenna codebooks assume a dual-polarized port layout, so applying the 8-port codebook to a single-polarized 4×2 port layout will lead to performance loss. In addition, because the 8-port CSI-RS is only transmitted from a subset of the array antennas, only a subset of the available transmit power is used and the CSI-RS coverage is reduced.

Therefore, it is beneficial for an overlapping CSI-RS resource definition to facilitate CSI calculation corresponding to the full antenna array dimension (so that all available beamforming gain can be utilized) and enable a precoder codebook, which captures the actual effective port layout, to be applied. This enables all of the available CSI-RS transmit power to be captured in the measurement.

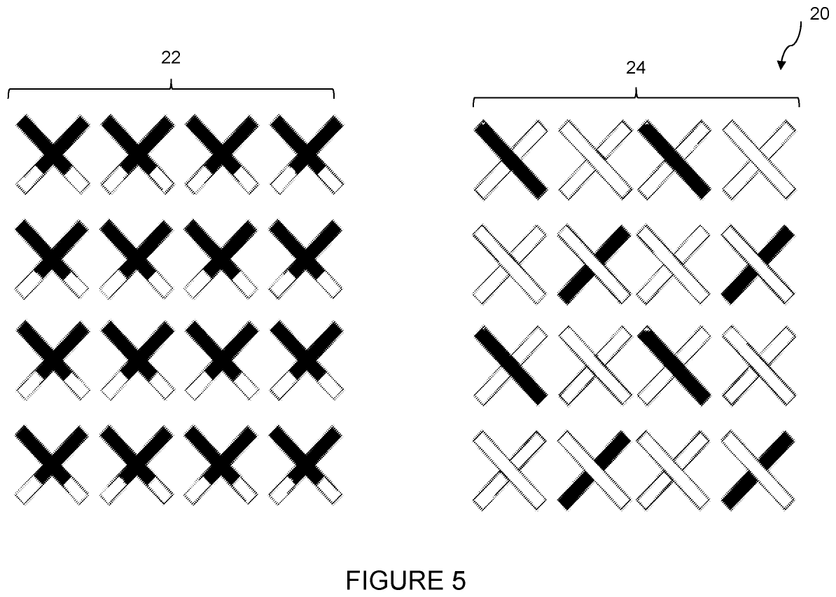

A first group of embodiments includes indicated port sub-selection. It is beneficial to flexibly indicate the port subsampling of a larger M-port CSI-RS resource to form the smaller N-port CSI-RS resource. For example, FIG. 5 illustrates an example port subsampling, according to certain embodiments. Specifically, FIG. 5 illustrates a new CSI-RS resource configuration 20 with arbitrary port subsampling. In the illustrated example, both polarizations of the antenna array are sounded, and, an 8-port precoder codebook with (N₁, N₂)=(2,2) port layout can be applied to the CSI-RS resource, so there is no loss due to codebook mismatch.

To support such an arbitrary port subsampling, a new CSI-RS resource definition is used, which comprises the configuration of an M-port “parent” CSI-RS resource 22 and a port subsampling indication, wherein the port subsampling indication indicates which N ports out of the M ports of the parent CSI-RS resource is used to form the new CSI-RS resource 24.

In some embodiments, the port subsampling indication is given by a size-M bitmap which comprises N bits which are set to one (and M-N bits which are set to zero). Each bit indicates if the port is included in the new CSI-RS resource or not. In the example of FIG. 5, the port subsampling indication according to this embodiment is given by ‘10100000101000000000010100000101’. An alternative way is to signal this information using a combinatorial numbering system, which then would use

$$⌈ {log}_{2} ( \begin{matrix}M \\ N\end{matrix} ) ⌉ bits .$$

A limitation with the previous embodiment is that the antenna port ordering of the new CSI-RS resource always must follow that of the parent CSI-RS resource, which may not always be desirable. Therefore, in some embodiments, the port subsampling indication is given as a list of N port indices.

In some embodiments, only a few candidate port subsamplings may be possible to configure. These candidate port subsamplings may be fixed in a specification and selected because they match the corresponding codebooks well. In that case, the port subsampling indication merely comprises an index pointing to one of the predefined candidates. As a special case, the number of candidate port subsamplings may be equal to one, whereby no explicit port subsampling indication is needed.

To further minimize UE processing, the selected N ports may be from a subset of Code Division Multiplexing (CDM) groups. For example, if N=8 and M=32, and CDM4 was configured for the 32 ports, which means 8 CDM groups where antenna ports in the first 4 CDM groups are on one polarization while antenna ports in the last 4 CDM groups are on a different polarization. Then the 8 ports may be selected from 2 of 8 CDM groups with the first 4 ports selected from the 1^{st} CDM group and the last 4 ports from the last CDM group. In this case, the UE processes only the 2 CDM groups instead of processing all 8 CDM groups.

In some embodiments, the lower complexity UE is indicated to measure only N out of the M CSI-RS ports in the ‘parent’ CSI-RS resource. Thus, in some cases the resource elements corresponding to the remaining M-N ports in the ‘parent’ CSI-RS resource are treated as PDSCH rate matching resources. That is, the low complexity UE's PDSCH Resource Elements (REs) are mapped around the resource elements corresponding to the remaining M-N ports in the ‘parent’ CSI-RS resource.

A second group of embodiments includes indicated port virtualization. A limitation with simply subsampling the CSI-RS antenna ports is that only a subset of the antenna array can be used for the subsequent PDSCH transmission based on the reported CSI, and thus, the achievable beamforming gain will be lower than if the entire array is used.

Typically, if the gNB is employed with more antennas than the UE or other wireless device is capable of measuring CSI-RS for, the gNB applies a virtualization to the physical antenna elements to form the smaller number of CSI-RS antenna ports. For example, given a 4×4 antenna setup, the gNB could virtualize each column of the antenna array to form a virtual subarray, so that each CSI-RS port is formed by the weighted sum of signals transmitted from four vertically stacked antennas of the same polarization. In general, how the M physical antennas are mapped to the N logical antenna ports can be described by a size M×N complex matrix called a virtualization matrix.

Generally, the complexity in CSI reporting corresponding to a large number of ports can lie in either the CSI-RS measurement of a large number of ports, the Precoder Matrix Indicator (PMI) calculation (i.e., codebook search) for large number of ports or both, depending on UE implementation. Thus, a UE may be able to perform measurement of all of the M CSI-RS ports but is only available to calculate PMI corresponding N CSI-RS ports.

Thus, particular embodiments include a new wireless device capability signaling where the wireless device indicates to the network the maximum number of antenna ports for codebook calculations used for CSI reporting. In previous NR releases, if a wireless device indicates that it supports M CSI-RS ports, then it is implicitly assumed that the wireless device supports CSI computation and thus PMI determination for M-port codebooks. Particular embodiments, however, separate the capability signaling for M CSI-RS ports and N-port codebook, where N<M, which facilitates a lower computational load for the wireless device to compute the CSI, compared to the N=M case.

To support this use case, particular embodiments use a new kind of “virtual” N-port CSI-RS resource definition, wherein the virtual CSI-RS resource configuration comprises configuring an M-port “parent” CSI-RS resource and additionally configuring the wireless device with a port virtualization down to N CSI-RS ports. The virtual CSI-RS resource may then be formed at the wireless device side by applying the indicated port virtualization to the measured M-port CSI-RS resource.

In some embodiments, the port virtualization is indicated from the network to the wireless device by indicating a virtualization matrix comprising M×N complex numbers. For example, each complex number may be quantized using a number of bits for gain and phase, respectively. The wireless device may then form a channel estimate 15 of the N-port virtual CSI-RS resource by multiplying the virtualization matrix F∈ [symbol] ^{M×N} with the measured estimate H∈ [symbol] ^{N}^{_{Rx}}^{×M} of the parent CSI-RS resource as Hᵥᵢᵣₜ=HF∈ [symbol] ^{N}^{_{Rx}}^{×N}.

In some embodiments, the port virtualization is indicated from the network to the wireless device by indicating a virtualization vector f∈ [symbol] ^{M/N×1}. The vector f is then applied per antenna column, per polarization, creating virtual subarrays of antenna ports, per polarization.

In some embodiments, a single virtualization vector f∈ [symbol] ^{M/N×1} or matrix F∈ [symbol] ^{M×N} is specified in specifications (per N and M), and only the value N is additionally indicated from the network to the wireless device, and the wireless device then applies the specified virtualization of the CSI-RS resource that is associated with the CSI report. Indicating the value N may be implicit through the indication of the codebook to use for the CSI report.

For example, if the wireless device is configured with a CSI-RS of M=32 ports, N₂=4 columns, but a CSI report with a codebook of only N=8 ports, then the wireless device shall use the 4×1 pre-defined virtualization vector f∈ [symbol] ^{M/N×1} or matrix F∈ [symbol] ^{M×N} when reporting CSI.

In some embodiments, the virtualization vector

$$f ∈ {\frac{M}{N} \times 1}^{}$$

belonging to a set of DFT vectors in one dimension, e.g., vertical dimension, may be specified or configured and one of the vectors is indicated to a wireless device to apply to the received CSI-RS signals from antenna ports in each column for each polarization. For the example illustrated in FIG. 5, the DFT vectors would be 4×1 vectors. In this case, it effectively virtualizes the 32 ports antenna into 8 ports along the horizontal direction. An 8 ports type 1 codebook can then be used for CSI feedback.

In some embodiments, the subarray virtualization vector is described in specifications to consist of M/N equal real valued values, that is f=[1 1 . . . 1]^{T}/\sqrt{M/N}.

A third group of embodiments includes an indication of CSI-RS sequence generation. In NR Rel-15, the starting position and the number of resource blocks in which the wireless device assumes CSI-RS is transmitted are given by the higher-layer parameters freqBand and density in the CSI-RS-ResourceMapping IE. Using this information and other relevant parameters (as described above), the CSI-RS sequence r(m) is generated and mapped on to different resource elements within different PRBs. The index m is a function of the relative PRB index n, the density ρ, the number of ports X (given in Table 1), and the quantities k′ and k̅ as defined in Table 1.

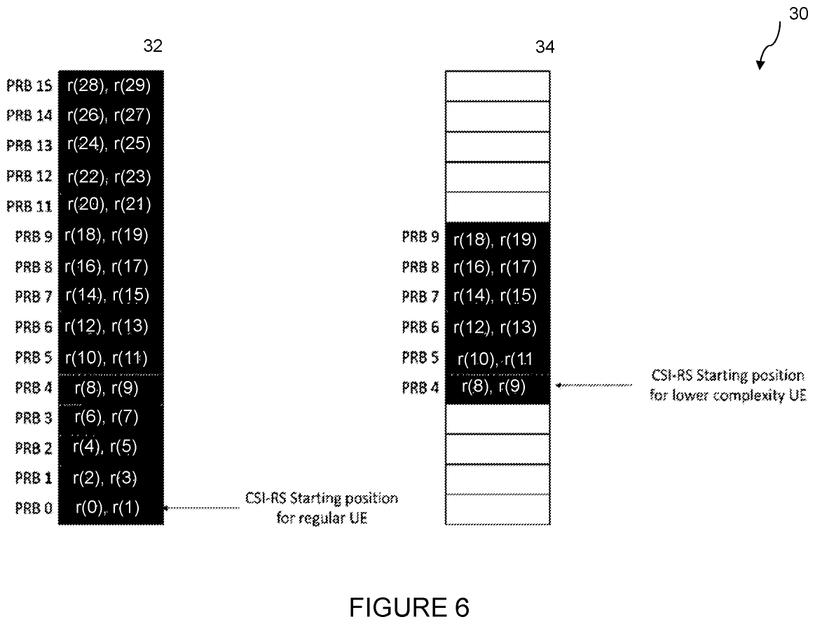

However, another issue with reusing an M-port ‘parent’ CSI-RS resource for a UE with lower complexity that measures on a smaller number N of ports is that the CSI-RS bandwidth for the UE with lower complexity might be smaller than the bandwidth of the ‘parent’ CSI-RS. FIG. 6 illustrates an example 30 where a ‘parent’ CSI-RS 32 has a larger CSI-RS bandwidth compared to CSI-RS bandwidth 34 of a lower complexity device, according to certain embodiments.

The ‘parent’ CSI-RS 32 in this example uses 2 ports, starting at PRB 0, and ending at PRB 15. Thus, sequence values r(0) and r(1) are mapped to PRB 0, r(2) and r(3) are mapped to PRB 1, and so forth.

The lower complexity UE receives CSI-RS starting at PRB 4 with a CSI-RS bandwidth of 6 PRBs. Because the ‘parent’ CSI-RS resource is reused for the lower complexity UE's CSI-RS measurements (with fewer ports than ‘parent’ CSI-RS), for proper channel measurement on CSI-RS at the lower complexity UE, sequence values r(8) and r(9) should be mapped to PRB 4, r(10) and r(11) should be mapped to PRB 5, and so forth. This can be achieved via the following variants of this group of embodiments:

In some embodiments, the ‘parent’ CSI-RS resource 32 is configured to the lower complexity UE along with a bit-map indicating which of the PRBs in the ‘parent’

CSI-RS resource 32 should be used for channel measurement by the lower complexity UE. The least significant bit in the bit-map corresponds to the starting position of the ‘parent’ CSI-RS and the most significant bit in the bit-map corresponds to the last PRB in which the ‘parent’ CSI-RS is transmitted. The bit-map can be signaled as part of the CSI-RS-ResourceMapping IE corresponding to the ‘parent’ CSI-RS. In the example of FIG. 6, the bit-map is 000011111100000 which indicates that PRBs 4-9 are to be used for channel measurement by the lower complexity UE. In this variant of the embodiment, because an explicit bitmap is signaled to the lower complexity UE along with the ‘parent’ CSI-RS resource, the lower complexity UE knows that sequence values r(8) and r(9) should be mapped to PRB4, sequence values r(10) and r(11) should be mapped to PRBS, etc.

In some embodiments, the ‘parent’ CSI-RS resource 32 is configured to the lower complexity UE along with a second set of starting position and number of resource blocks indicating where the lower complexity UE should measure its CSI-RS. A modified example CSI-RS-ResourceMapping IE is shown further below where freqBand gives the starting position/number of PRBs corresponding to the ‘parent’ CSI-RS while freqBandLowComplexity gives the starting position/number of PRBs corresponding to the CSI-RS of the lower complexity UE. In this case, when the lower complexity UE generates the sequence r(m′), an offset Δn (which represents the difference between the starting position of the ‘parent’ CSI-RS and the starting position of the lower complexity UE' s CSI-RS) is added to m′ as shown below:

m′=└(n+Δn)α┘+k′+└k̅ρ/N_{sc}^{RB}┘

### CSI-RS-ResourceMapping Information Element (IE)

```
-- ASN1START
-- TAG-CSI-RS-RESOURCEMAPPING-START
CSI-RS-ResourceMapping ::=  SEQUENCE {
  frequencyDomainAllocation  CHOICE {
    row1  BIT STRING (SIZE (4)),
    row2  BIT STRING (SIZE (12)),
    row4  BIT STRING (SIZE (3)),
    other  BIT STRING (SIZE (6))
  },
  nrofPorts  ENUMERATED {p1,p2,p4,p8,p12,p16,p24,p32},
  firstOFDMSymbolInTimeDomain  INTEGER (0.. 13),
  firstOFDMSymbolInTimeDomain2  INTEGER (2.. 12)
OPTIONAL, -- Need R
  cdm-Type  ENUMERATED {noCDM, fd-CDM2, cdm4-
FD2-TD2, cdm8-FD2-TD4},
  density  CHOICE {
    dot5  ENUMERATED {evenPRBs, oddPRBs},
    one  NULL,
    three  NULL,
    spare  NULL
  },
  freqBand  CSI-FrequencyOccupation,
    freqBandLowComplexity  CSI-FrequencyOccupation,
  . . .
}
-- TAG-CSI-RS-RESOURCEMAPPING-STOP
-- ASN1STOP
```

### CSI-FrequencyOccupation Information Element

```
-- ASN1START
-- TAG-CSI-FREQUENCYOCCUPATION-START
CSI-FrequencyOccupation ::=  SEQUENCE {
  startingRB  INTEGER (0..maxNrofPhysicalResourceBlocks-1),
  nrofRBs INTEGER
(24..maxNrofPhysicalResourceBlocksPlus1),
  . . .
}
-- TAG-CSI-FREQUENCYOCCUPATION-STOP
-- ASN1STOP
```

In some embodiments, the ‘parent’ CSI-RS resource 32 is configured to the lower complexity UE and where the lower complexity UE should measure its CSI-RS is indicated via a bandwidth part location and bandwidth. In this case, when the lower complexity UE generates the sequence r(m′), an offset Δn (which represents the difference between the starting position of the ‘parent’ CSI-RS and the first PRB of the lower complexity UE's bandwidth part) is added to m′ as shown below:

m′=└(n+Δn)α┘+k′+└k̅ρ/N_{sc}^{RB}┘

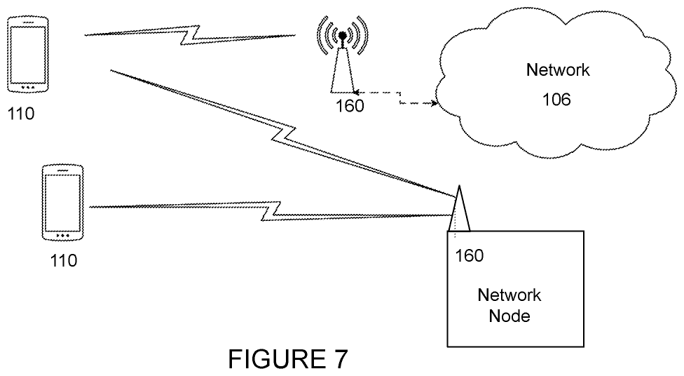

FIG. 7 illustrates an example wireless network in accordance with some embodiments. Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

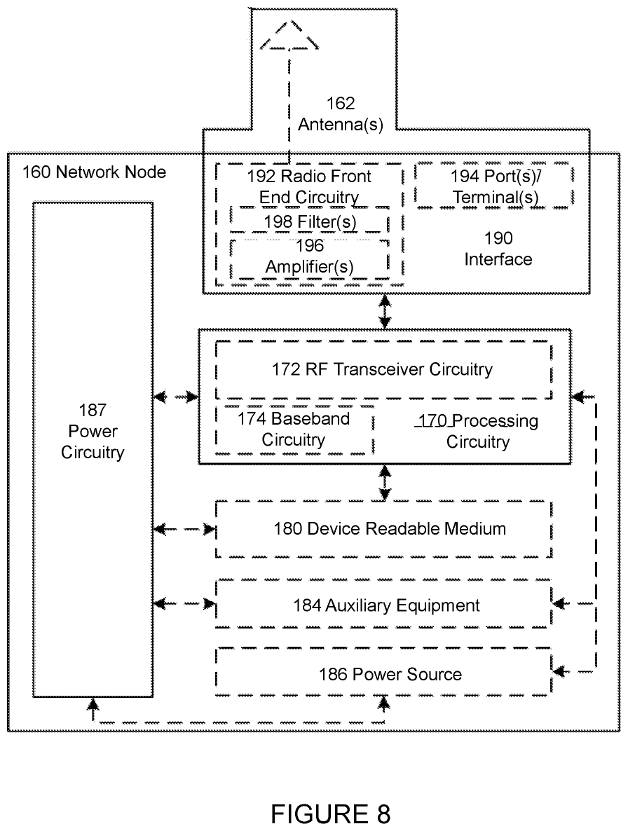

FIG. 8 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NRNodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entities (MMEs)), Operation and Maintenance (O&M) nodes, Operations Support System (OSS) nodes, Self Optimized Network (SON) nodes, positioning nodes (e.g., Evolved-Serving Mobile Location Centres (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 160 includes processing circuitry 170, device readable medium 180, interface 190, auxiliary equipment 184, power source 186, power circuitry 187, and antenna 162. Although network node 160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 8 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

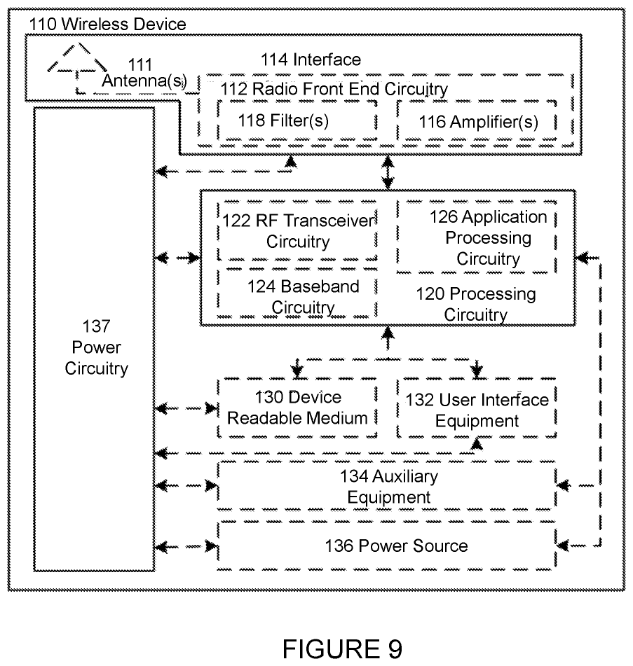

FIG. 9 illustrates an example wireless device (WD), according to certain embodiments. As used herein, WD refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

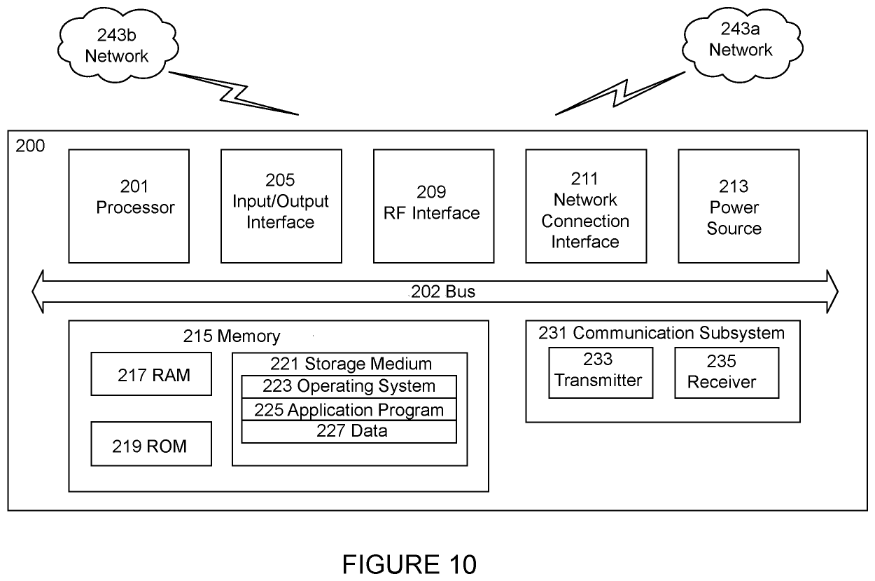

FIG. 10 illustrates one embodiment of a UE 200 in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory

(EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, Code Division Multiplexing Access (CDMA), Wide Code Division Multiplexing Access (WCDMA), Global System for Mobile Communication (GSM), Long Term Evolution (LTE),

Universal Terrestrial Radio Access Network (UTRAN), WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

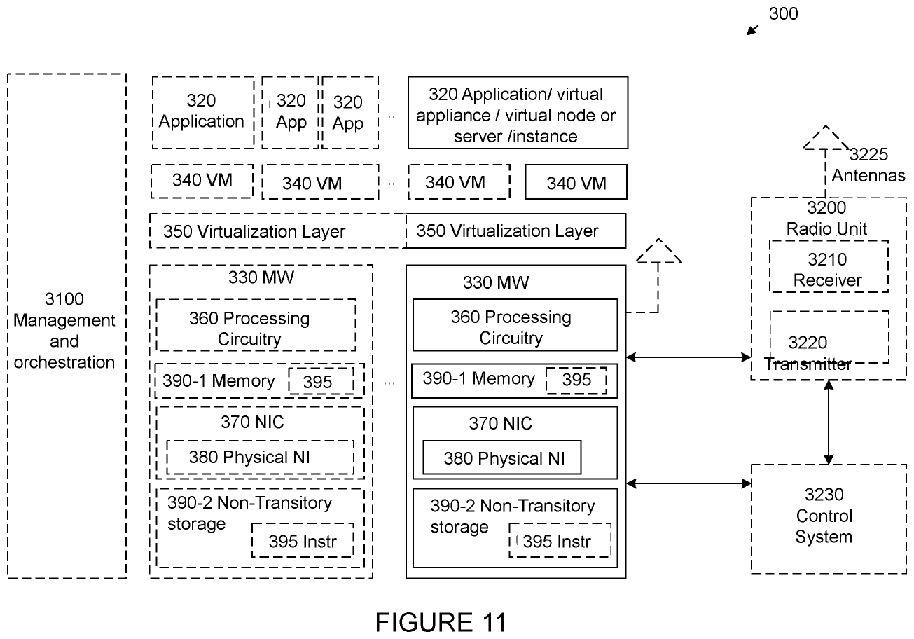

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 11.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

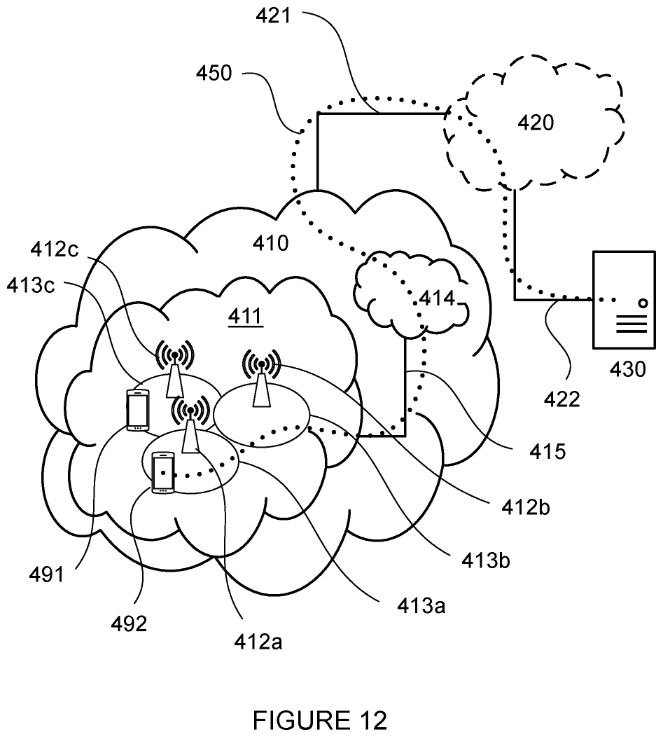

FIG. 12 illustrates an example telecommunication network connected via an intermediate network to a host computer in accordance with some embodiments.

With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

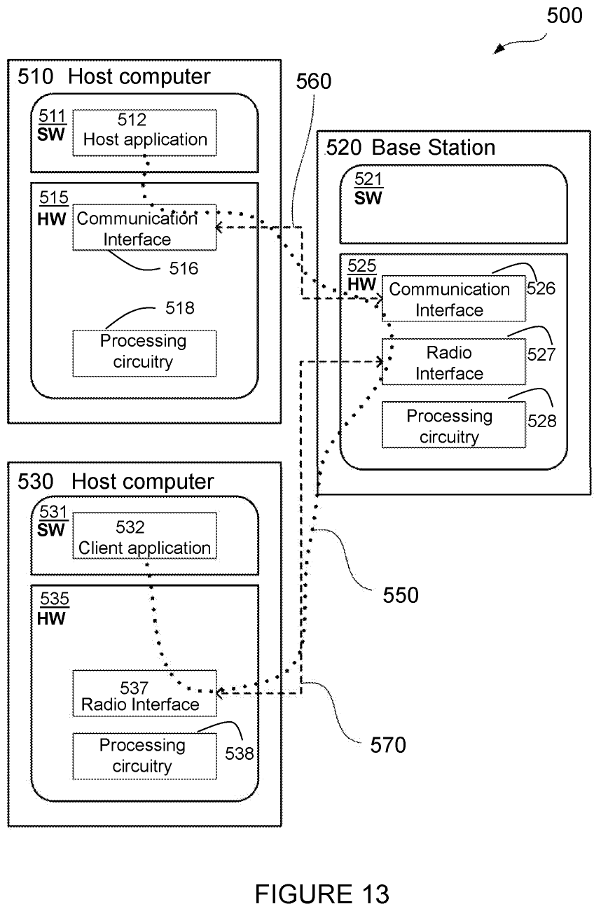

FIG. 13 illustrates an example host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

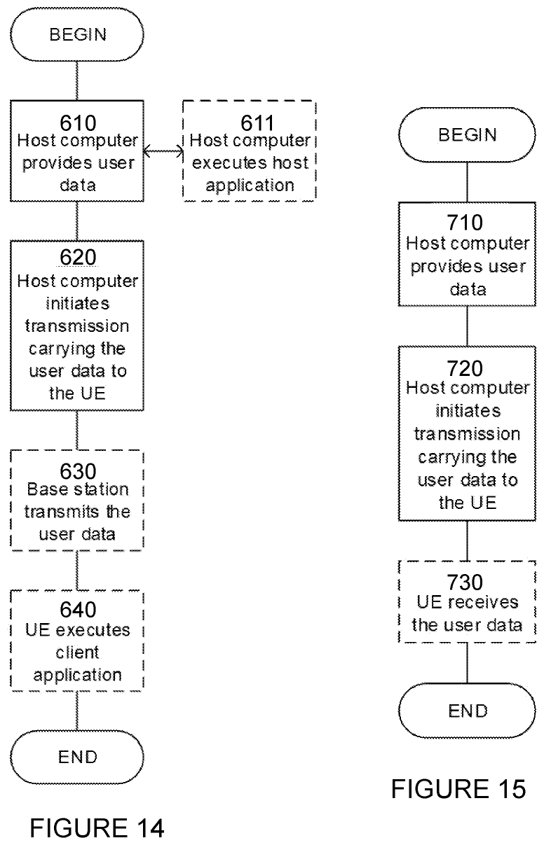

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

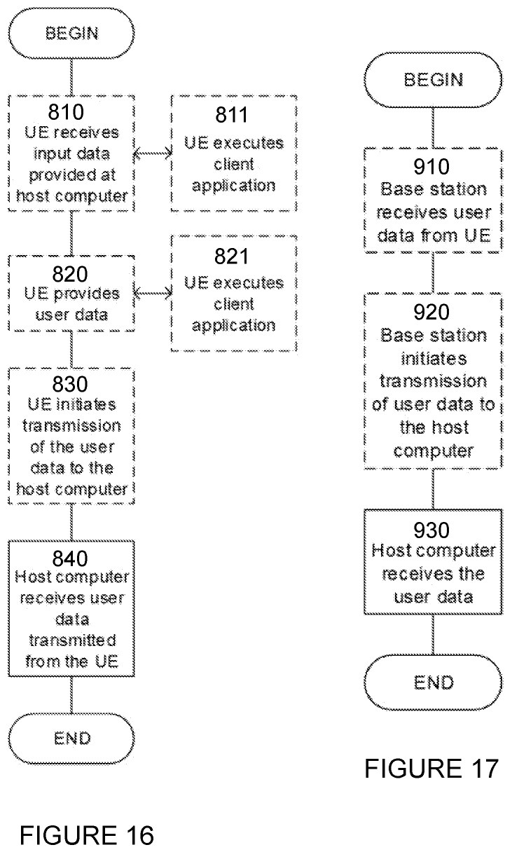

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

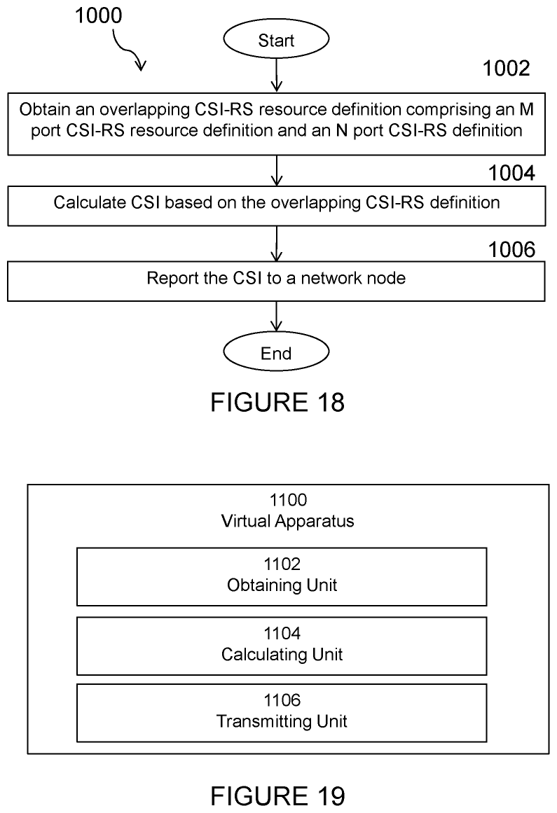

FIG. 18 depicts a method 1000 by a wireless device 110, in accordance with particular embodiments. The method begins at step 1002 with the wireless device 110 obtaining an overlapping CSI-RS resource definition comprising an M port CSI-RS resource definition and an N port CSI-RS resource definition, wherein N is less than M and the N ports are a subset of the M ports. The wireless device 110 may obtain the overlapping mapping from a network node 160, or the wireless device 110 may be preconfigured with the overlapping pattern based on network operator preference, a standards-based configuration, etc. The overlapping mapping may be according to any of the first, second, and/or third group of embodiments described above.

At step 1004, the wireless device 110 calculates CSI based on the overlapping CSI-RS definition. The wireless device 110 calculates the CSI be according to any of the first, second, and/or third group of embodiments described above. At step 1006, the wireless device 110 reports the CSI to a network node 160.

FIG. 19 illustrates a schematic block diagram of an apparatus 1100 in a wireless network (for example, the wireless network shown in FIG. 7). The apparatus may be implemented in a wireless device or network node (e.g., wireless device 110 or network node 160 shown in FIG. 7). Apparatus 1100 is operable to carry out the example method described with reference to FIG. 18 and possibly any other processes or methods disclosed herein. It is also to be understood that the method of FIG. 18 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 1102, calculating unit 1104, and .transmitting unit 1106, and any other suitable units of apparatus 1100 to perform corresponding functions according one or more embodiments of the present disclosure.

As illustrated in FIG. 19, apparatus 1100 includes obtaining unit 1102, calculating unit 1104, and transmitting unit 1106. Obtaining unit 1102 is configured to obtain an overlapping CSI-RS resource definition comprising an M port CSI-RS resource definition and an N port CSI-RS resource definition, wherein N is less than M and the N ports are a subset of the M ports, according to any of the first, second, and/or third group of embodiments described above. Calculating unit 1104 is configured to calculate CSI based on the overlapping CSI-RS definition, according to any of the first, second, and/or third group of embodiments described above. Transmitting unit 1106 is configured to transmit a CSI report to a network node.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

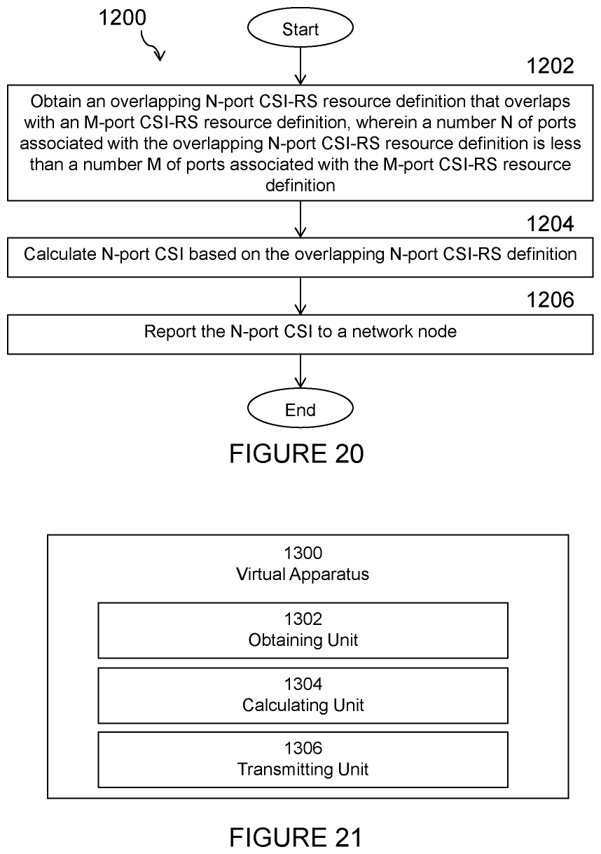

FIG. 20 depicts another method 1200 by a wireless device 110 for calculating or computing channel state information (CSI), in accordance with particular embodiments. The method begins at step 1202 with the wireless device 110 obtaining an overlapping N-port CSI-RS resource definition that overlaps with and/or is included in an M-port CSI-RS resource definition. A number N of ports associated with the overlapping N-port CSI-RS resource definition is less than a number M of ports associated with the M-port CSI-RS resource definition. At step 1204, the wireless device 110 calculates, or computes, N-port CSI based on the overlapping N-port CSI-RS resource definition. At step 1206, the wireless device reports the N-port CSI to a network node 160.

In a particular embodiment, at least one resource element associated with the overlapping N-port CSI-RS resource definition is comprised within the M-port CSI-RS resource definition. As such, the overlapping N-port CSI-RS resource definition overlaps with the M-port CSI-RS resource definition.

In a particular embodiment, the N ports are a subset of the M ports.

In a particular embodiment, the number M of ports is 32 and the number N of ports is 8.

In a particular embodiment, obtaining the overlapping N-port CSI-RS resource definition includes receiving, from a network node, the M-port CSI-RS resource definition and determining the overlapping N-port CSI-RS resource definition based on the M-port CSI-RS resource definition.

In a particular embodiment, obtaining the overlapping N-port CSI-RS definition includes receiving, from a network node, the overlapping N-port CSI-RS resource definition.

In a particular embodiment, calculating the N-port CSI based on the N-port CSI-RS resource definition includes: performing at least one channel measurement on the N ports and calculating, or computing, the N-port CSI based on the at least one channel measurement on the N ports. In a further particular embodiment, when calculating, or computing, the N-port CSI, the wireless device 110 calculates a PMI according to an N-port codebook.

In a further particular embodiment, the N ports include both polarizations of an M-port antenna array.

In a particular embodiment, calculating, or computing, the N-port CSI based on the overlapping N-port CSI-RS resource definition includes: performing at least one channel measurement on the M ports; applying an antenna virtualization from the M-port CSI-RS resource definition to the at least one channel measurement to form the overlapping N-port CSI-RS resource definition; and calculating a PMI according to an N-port codebook. In a further particular embodiment, the wireless device 110 receives an indication of the antenna virtualization from the network node 160.

In a further particular embodiment, the antenna virtualization includes a matrix or a vector and applying the antenna virtualization comprises multiplying the matrix or vector with the at least one channel measurement on the M ports.

In a further particular embodiment, the wireless device receives the antenna virtualization with the overlapping N-port CSI-RS resource definition.

In a particular embodiment, obtaining the overlapping N-port CSI-RS resource definition includes receiving, from the network node 160, an indication of which PRBs of the M-port CSI-RS resource definition are used for the overlapping N-Port CSI-RS resource definition. In a further particular embodiment, the indication is at least one of a bitmap, an offset, and a bandwidth part.

In a particular embodiment, obtaining the overlapping N-port CSI-RS resource definition includes receiving, from a network node 160, a port subsampling indication comprising a list of N port indices.

In a particular embodiment, prior to obtaining the overlapping N-port CSI-RS resource definition, the wireless device 110 signals to the network node 160, a capability of the wireless device. The capability includes a maximum number of antenna ports for performing codebook calculations used for CSI.

FIG. 21 illustrates a schematic block diagram of an apparatus 1300 in a wireless network (for example, the wireless network shown in FIG. 7). The apparatus may be implemented in a wireless device or network node (e.g., wireless device 110 or network node 160 shown in FIGS. 7-9). Apparatus 1300 is operable to carry out the example method described with reference to FIG. 20 and possibly any other processes or methods disclosed herein. It is also to be understood that the method of FIG. 20 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 1302, calculating unit 1304, and transmitting unit 1306, and any other suitable units of apparatus 1300 to perform corresponding functions according one or more embodiments of the present disclosure.

As illustrated in FIG. 21, apparatus 1300 includes obtaining unit 1302, calculating unit 1304, and transmitting unit 1306. Obtaining unit 1302 is configured to obtain an overlapping N-port CSI-RS resource definition that overlaps with and/or is included in an M-port CSI-RS resource definition. A number N of ports associated with the overlapping N-port CSI-RS resource definition is less than a number M of ports associated with the M-port CSI-RS resource definition.

Calculating unit 1304 is configured to calculate, or compute, N-port CSI based on the overlapping N-port CSI-RS definition.

Transmitting unit 1306 is configured to report the N-port CSI to a network node 160.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, such as those that are described herein.

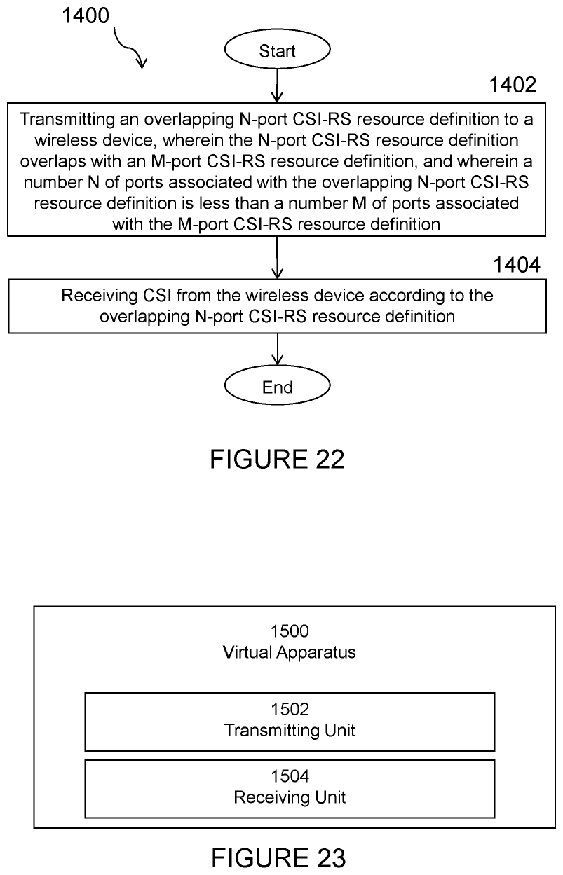

FIG. 22 depicts a method 1400 by a network node 160 for receiving channel state information (CSI), in accordance with particular embodiments. The method begins at step 1402 when network node 160 transmits an overlapping N-port channel state information-reference signal, CSI-RS, resource definition to a wireless device 110. The overlapping N-port CSI-RS resource definition overlaps with an M-port CSI-RS resource definition. A number N of ports associated with the overlapping N-port CSI-RS resource definition is less than a number M of ports associated with the M-port CSI-RS resource definition. At step 1404, the network node 160 receives CSI, e.g. N-port CSI, from the wireless device 110 according to the overlapping N-port CSI-RS resource definition.

In a particular embodiment, at least one resource element associated with the overlapping N-port CSI-RS resource definition is comprised or included within the M-port CSI-RS resource definition. As such, the N-port CSI-RS resource definition overlaps with the M-port CSI-RS resource definition.

In a particular embodiment, the N ports are a subset of the M ports.

In a particular embodiment, the number M of ports is 32 and the number N of ports is 8.

In a particular embodiment, the network node 160 defines, e.g. by forming or determining, the overlapping N-port CSI-RS resource definition based on the M-port CSI-RS resource definition.

In a particular embodiment, the N ports include both polarizations of an M-port antenna array and a PMI is to be calculated by the wireless device according to an N-port codebook.

In a particular embodiment, the network node 160 defines, e.g. by forming or determining, the overlapping N-port CSI-RS resource definition by identifying, from the M-port CSI-RS resource definition, an antenna virtualization to be applied to at least one channel measurement of the M ports to form the overlapping N-port CSI-RS resource definition.

In a further particular embodiment, the antenna virtualization comprises a matrix or a vector.

In a particular embodiment, the network node 160 transmits an indication of the antenna virtualization to the wireless device 110.

In a particular embodiment, the overlapping N-port CSI-RS resource definition includes an indication of which PRBs of the M-port CSI-RS resource definition are used for the overlapping N-Port CSI-RS resource definition. In a further particular embodiment, the indication is at least one of a bitmap, an offset, and a bandwidth part.

In a particular embodiment, transmitting the overlapping N-port CSI-RS resource definition includes transmitting, to the wireless device, a port subsampling indication comprising a list of N port indices.

In a particular embodiment, prior to transmitting the overlapping N-port CSI-RS resource definition to the wireless device 110, the network node 160 receives, from the wireless device 110, signaling indicating a capability of the wireless device 110. The capability includes a maximum number of antenna ports for performing codebook calculations used for CSI.

FIG. 23 illustrates a schematic block diagram of an apparatus 1500 in a wireless network (for example, the wireless network shown in FIG. 7). The apparatus may be implemented in a wireless device or network node (e.g., wireless device 110 or network node 160 shown in FIGS. 7-9). Apparatus 1500 is operable to carry out the example method described with reference to FIG. 22 and possibly any other processes or methods disclosed herein. It is also to be understood that the method of FIG. 22 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1502, receiving unit 1504, and any other suitable units of apparatus 1500 to perform corresponding functions according one or more embodiments of the present disclosure.

As illustrated in FIG. 23, apparatus 1500 includes transmitting unit 1502 and receiving unit 1504. Constructing unit 1502 is configured to construct an overlapping N-port channel state information-reference signal, CSI-RS, resource definition comprising an M-port CSI-RS resource definition.

Transmitting unit 1502 is configured to transmit an overlapping N-port CSI-RS resource definition to a wireless device 110. The overlapping N-port CSI-RS resource definition overlaps with an M-port CSI-RS resource definition, and a number N of ports associated with the overlapping N-port CSI-RS resource definition is less than a number M of ports associated with the M-port CSI-RS resource definition.

Receiving unit 1504 is configured to receive N-port CSI from the wireless device 110 according to the overlapping N-port CSI-RS resource definition.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, such as those that are described herein.

### EXAMPLES

Example E1. A method performed by a wireless device for calculating channel state information (CSI), the method comprising: obtaining an overlapping CSI-RS resource definition comprising an M port CSI-RS resource definition and an N port CSI-RS resource definition, wherein N is less than M and the N ports are a subset of the M ports; calculating CSI based on the overlapping CSI-RS definition; and reporting the CSI to a network node.

Example E2. The method of Example E1, wherein calculating CSI based on the overlapping CSI-RS definition comprises: measuring the N ports, wherein the N ports include both polarizations of an M port antenna array, calculating PMI according to an N-port codebook, and calculating the CSI based on the N port measurements.

Example E3. The method of Example E1, wherein calculating CSI based on the overlapping CSI-RS definition comprises: measuring the M ports, applying an antenna virtualization to form N CSI-RS ports, and calculating PMI according to an N-port codebook.

Example E4. The method of Example E1, wherein the overlapping CSI-RS resource definition includes an indication of which PRBs of the M-port CSI-RS resource definition are used for the N-Port CSI-RS resource definition.

Example E5. The method of Example E4, wherein the indication is one of a bitmap, and offset, or a bandwidth part.

Example E6. The method of any of the previous Examples, further comprising: providing user data; and forwarding the user data to a host computer via the transmission to the base station.

Example E7. A method performed by a base station for receiving channel state information (CSI), the method comprising: obtaining an overlapping CSI-RS resource definition comprising an M port CSI-RS resource definition and an N port CSI-RS resource definition, wherein N is less than M and the N ports are a subset of the M ports; transmitting the overlapping CSI-RS resource definition to a wireless device; and receiving CSI from the wireless device according to the overlapping CSI-RS resource definition.

Example E8. The method of Example E7, wherein the N ports include both polarizations of an M port antenna array and PMI is calculated according to an N-port codebook.

Example E9. The method of Example E7, wherein the overlapping CSI-RS definition comprises an antenna virtualization to form N CSI-RS ports from the M CSI-RS ports.

Example E10. The method of Example E1, wherein the overlapping CSI-RS resource definition includes an indication of which PRBs of the M-port CSI-RS resource definition are used for the N-Port CSI-RS resource definition.

Example E11. The method of Example E4, wherein the indication is one of a bitmap, and offset, or a bandwidth part.

Example E12. The method of any of the previous Examples, further comprising: obtaining user data; and forwarding the user data to a host computer or a wireless device.

Example E13. A wireless device for calculating channel state information (CSI), the wireless device comprising: processing circuitry configured to perform any of the steps of any of Examples E1 to E6; and power supply circuitry configured to supply power to the wireless device.

Example E14. A base station for receiving channel state information (CSI), the base station comprising: processing circuitry configured to perform any of the steps of any of Example Embodiments 7 to 12; power supply circuitry configured to supply power to the wireless device.

1.-32. (canceled)

33. A method by a wireless device for computing channel state information, CSI, the method comprising:
obtaining an overlapping N-port channel state information-reference signal, CSI-RS, resource definition that overlaps with an M-port CSI-RS resource definition, wherein obtaining the overlapping N-port CSI-RS definition comprises:
receiving, from a network node, the M-port CSI-RS resource definition; and
determining the overlapping N-port CSI-RS resource definition based on the received M-port CSI-RS resource definition;
wherein a number N of ports associated with the overlapping N-port CSI-RS resource definition is less than a number M of ports associated with the M-port CSI-RS resource definition;
calculating N-port CSI based on the overlapping N-port CSI-RS resource definition; and
reporting the N-port CSI to the network node.

34. The method of claim 33, wherein at least one resource element associated with the overlapping N-port CSI-RS resource definition is comprised within the M-port CSI-RS resource definition.

35. The method of claim 33, wherein calculating the N-port CSI based on the N-port CSI-RS resource definition comprises:
performing at least one channel measurement on the N ports; and
calculating the N-port CSI based on the at least one channel measurement on the N ports, wherein the calculating comprises calculating a precoder matrix indicator, PMI, according to an N-port codebook.

36. The method of claim 33, wherein calculating the N-port CSI based on the overlapping N-port CSI-RS resource definition comprises:
performing at least one channel measurement on the M ports,
applying an antenna virtualization to the at least one channel measurement on the M ports to linearly map the M-port CSI-RS resource definition to the overlapping N-port CSI-RS resource definition, and
calculating a precoder matrix indicator, PMI, according to an N-port codebook.

37. The method of claim 36, further comprising receiving an indication of the antenna virtualization from the network node.

38. The method of claim 33, wherein obtaining the overlapping N-port CSI-RS resource definition comprises receiving, from the network node, an indication of which physical resource blocks, PRBs, of the M-port CSI-RS resource definition are used for the overlapping N-Port CSI-RS resource definition.

39. The method of claim 38, wherein the indication is at least one of a bitmap, an offset, and a bandwidth part.

40. The method of claim 33, wherein obtaining the overlapping N-port CSI-RS resource definition comprises receiving, from the network node, a port subsampling indication comprising a list of N port indices.

41. The method of claim 33, further comprising signaling to the network node, a capability of the wireless device, the capability comprising a maximum number of antenna ports for performing codebook calculations used for CSI.

42. A method by a network node for receiving channel state information, CSI, the method comprising:
defining an overlapping N-port channel state information-reference signal, CSI-RS, resource definition based on an M-port CSI-RS resource definition, wherein the overlapping N-port CSI-RS resource definition overlaps with the M-port CSI-RS resource definition, and wherein a number N of ports associated with the overlapping N-port CSI-RS resource definition is less than a number M of ports associated with the M-port CSI-RS resource definition;
transmitting, to a wireless device, the M-port CSI-RS resource definition; and
receiving, from the wireless device, N-port CSI according to the overlapping N-port CSI-RS resource definition.

43. The method of claim 42, wherein at least one resource element associated with the overlapping N-port CSI-RS resource definition is comprised within the M-port CSI-RS resource definition.

44. The method of claim 42, wherein the N ports include both polarizations of an M-port antenna array and wherein a precoder matrix indicator, PMI, is to be calculated by the wireless device according to an N-port codebook.

45. The method of claim 42, further comprising defining the overlapping N-port CSI-RS resource definition by identifying, from the M-port CSI-RS resource definition, an antenna virtualization to be applied to at least one channel measurement of the M ports to form the overlapping N-port CSI-RS resource definition.

46. The method of claim 45, further comprising transmitting, to the wireless device, an indication of the antenna virtualization.

47. The method of claim 42, further comprising transmitting, to the wireless device, an indication of which physical resource blocks, PRBs, of the M-port CSI-RS resource definition are used for the overlapping N-Port CSI-RS resource definition.

48. The method of claim 47, wherein the indication is at least one of a bitmap, an offset, and a bandwidth part.

49. The method of claim 42, further comprising transmitting, to the wireless device, a port subsampling indication comprising a list of N port indices.

50. The method of claim 42, further comprising:
receiving, from the wireless device, signaling indicating a capability of the wireless device, the capability comprising a maximum number of antenna ports for performing codebook calculations used for CSI.

51. A wireless device for computing channel state information, CSI, the wireless device comprising processing circuitry configured to perform the method of claim 33.

52. A network node for receiving channel state information, CSI, the network node comprising processing circuitry configured to perform the method of claim 42.
